(19) United States
(12) Patent Application Publication
(10) Pub. No.: US 2026/0078667 A1
(43) Pub. Date: Mar. 19, 2026

(54) Self-Sensing Materials for Passive and Telemetrical Structure Health Monitoring

(71) Applicant: U.S. Department of Energy, Lemont, IL (US)

(72) Inventors: Yifeng Wang, Sarasota, FL (US); Nicholas Karl, Albuquerque, NM (US); Yongliang Xiong, Albuquerque, NM (US); Cory Marquez, Belen, NM (US); Yirong Lin, EL Paso, TX (US)

(73) Assignee: United States Department of Energy, Lemont, IL (US)

(21) Appl. No.: 18/883,734

(22) Filed: Sep. 12, 2024

Related U.S. Application Data
(60) Provisional application No. 63/539,079, filed on Sep. 18, 2023.

(51) Int. Cl. E21B 47/005; E21B 47/13; G01N 22/00

(52) U.S. Cl. CPC E21B 47/005; E21B 47/13; G01N 22/00

(57) ABSTRACT

Structural health monitoring (SHM) of an engineered component in a harsh environment is critical for multiple DOE missions including nuclear fuel cycle, subsurface energy production/storage, and energy conversion. The present invention provides a concept for SHM by introducing a self-sensing capability into structural components. The concept employs metamaterials and additive manufacturing. A self-sensing capability was engineered by embedding a metastructure, with a sheet of electromagnetic resonators, either metallic or dielectric, into a material component. The embedment was accomplished by 3-D printing. The precise geometry of the embedded metastructure determines how the material interacts with an incident electromagnetic wave. Change in structure of the material inevitably affects the embedded metastructures/metasurface array and alters the electromagnetic response of the material. A frequency shift of a reflection spectrum is detected passively and remotely for SHM. The approach eliminates complicated environmental shielding, in-situ power supply, and wire routing generally required by existing active-circuit-based sensors.

### GOVERNMENT SUPPORT

This invention was made with government support under Prime Contract No. DE-AC52-06NA252396 awarded by the U.S. Department of Energy. The government has certain rights in the invention.

### FIELD OF INVENTION

The present invention relates, generally, to a novel Structural Health Monitoring (SHM) concept in which a structural material can be constructed with a built-in self-sensing capability such that the structural integrity of the material can be monitored passively and telemetrically with an external electromagnetic wave. The new sensing approach will eliminate complicated environmental shielding, in-situ power supply, and wire routing that are generally required by the existing active-circuit-based sensors, thus opening a new avenue for SHM in extreme environments encountered in many energy-related applications.

### BACKGROUND OF THE INVENTION

Structural health monitoring (SHM) in a harsh environment is critical for nuclear fuel cycle, subsurface energy production/storage, and energy conversion (e.g., a supercritical CO2 Brayton cycle). Over the past few decades, several effective structural health monitoring techniques have been developed including strain measurements, electro-mechanical impedance, scattering of guided waves, acoustic emissions, dynamic response, and optical techniques [1].

Various sensors such as strain gauges, piezoelectric sensors and optical fiber sensors have been used. These sensors generally require an in-situ power supply. When a sensor detects a structural change, it needs to transmit the information to a data acquisition system that may be located far away from the structure to be monitored. The requirement for a wire connection for power and data transmission often renders a monitoring system difficult to implement and maintain. A whole structure sometimes needs to be redesigned to accommodate sensors and their connections, thus significantly increasing the cost. The implementation of a wired sensor for monitoring a moving part of a structural system is technically challenging, if not impossible. In many subsurface applications (e.g., in a borehole), the accommodation of sensors and their connections becomes very difficult or impossible because of limited physical access. Therefore, wireless sensors are an ideal solution for these systems. However, the existing wireless sensors have severe limitations. They are mostly based on active sensing modes that require in-situ energy storage devices (e.g., batteries) and the associated electronic components, which cannot endure high temperature and chemically corrosive environments commonly encountered in energy related applications [2]. Optical sensors such as pyrometers, fluorescence thermometers, fiber Bragg gratings and surface acoustic wave (SAW) sensors have been considered [2].

However, they are all limited by low temperature capability of optical fibers, cross-sensitivity issues from fiber Bragg gratings, or by the degradation of material properties in harsh environments that affect their responses [2,3]. Recently, LC resonator and inductive coupling have been reported for high temperature applications [4]. But these sensors are restricted in coil orientation, size, and distance to material surfaces [2]. Importantly, all existing sensing technologies, whether wired or wireless and active or passive, are only able to monitor structural changes at a limited number of spatial points of a structural system.

For many energy-related applications, however, it would be highly desirable to have a capability to detect such changes over an extended 2-D or 3-D physical domain. Therefore, due to the operational or system integration limitations, the existing sensor technologies have reached their limits to address the key challenges in structural health monitoring technology. There is a need for new paradigm for monitoring.

### SUMMARY OF THE INVENTION

The present invention is directed to two recent technological advances: metamaterials and additive manufacturing. A self-sensing capability can be engineered by embedding a metastructure. For example, a sheet of electromagnetic resonators, either metallic or dielectric, into a material component (FIG. 1). The embedding process can be accomplished using 3-D printing. The precise geometry of the embedded metastructure determines how the material will interact with an incident electromagnetic wave. Any change in the structure of the material inevitably perturbates the embedded metastructures or metasurface array, and therefore alter the electromagnetic response of the material, thus resulting in a frequency shift of a reflection spectrum that can be detected passively and remotely. Structural changes referred here include deformation, cracking/fracturing, chemical degradation, etc. The structural changes also include the change of a structural component in electromagnetic property due to the interaction of the component with the environment, for example, due to an imbibition of water into a porous structural component such as cement or unsintered clay blocks. The new sensing approach eliminates complicated environmental shielding, in-situ power supply, and wire routing that are generally required by the existing active-circuit-based sensors.

The present invention is directed to a method of manufacturing a structural component with sensing capability, comprising: a) embedding a metastructure with a sheet or multiple sheets of electromagnetic resonators or simply a layer of mesh or multiple layers of mesh of electrically conductive materials onto or beneath the surface of a structural material component forming embedded metastructures or metasurface arrays; and b) conducting the embedding process by 3-D printing. In a case of using meshes, the embedded meshes can be used for both sensing and structural reinforcement. The size of resonators or mesh holes is about one tenth of the wavelength of the electromagnetic wave used for sensing.

Another embodiment of the invention is directed to a method of manufacturing a structural component with sensing capability wherein the metasurface is selected from a group consisting of dielectric metasurface and plasmonic metasurface.

Another embodiment is directed to a method of manufacturing a structural component with sensing capability wherein the electromagnetic resonator is selected from a group consisting of electrically conductive material with electric resistivity <10⁻⁶ Ω·m or high dielectric constant material. A high dielectric constant material is selected such that the contrast in dielectric constant between the sensing material and the structural component is greater than 5.

Another embodiment of the invention is directed to a method of manufacturing a structural component with sensing capability wherein the material for metastructure is selected from ceramic or metal.

Another embodiment of the invention is directed to a method of manufacturing a structural component with sensing capability wherein the high dielectric constant material is selected from SrTiO₃, BaTiO₃, LaAlO₃, TiO₂, Nb₂O₅, Ta₂O₅, HfSiO₄, ZrO₂, Al₂O₃, silicon carbide, and other materials having dielectric constants higher than 5; preferably, 10-2000; most preferably, 10-200 to achieve a significant contrast in dielectric constant between the metastructure and the surrounding structural component.

Another embodiment of the invention is directed to a method of manufacturing a structural component with sensing capability wherein the electrically conductive material is a metal or a nonmetallic material. The metal is selected from a group consisting of copper, nickel, tungsten, aluminum, high entropy (HE) alloys, and combinations thereof. The nonmetallic conductive material is selected from graphite, conductive carbon fibers, and conductive polymers. The graphite is either graphene or carbon fiber. In a case of using mesh metastructure, the material can be selected for its best performance for both sensing and structural reinforcement. The preferred choice is carbon steel or stainless steel.

As used herein, high entropy (HE) alloys are usually composed of 5 or more elements that each have a content of 5% to 35%. The most common class of HE alloys are those with elements mixed in equal molar proportions. The alloy design method will fully increase the entropy value of an alloy system, and thus a resulting alloy is called HE alloy. HE alloys have a range of excellent properties, such as high hardness, wear resistance, and corrosion resistance. (US Patent Publication 2024024599).

A preferred embodiment for the metal is copper; most preferably, tungsten or a HE alloy (FeCoNiCrCu).

Another embodiment of the invention is directed to a method wherein the plasmonic metasurface comprises multiple split ring resonator metal structure.

Another embodiment of the invention is directed to a method of manufacturing a structural component with sensing capability wherein the electromagnetic resonator is selected from a group consisting of closed ring resonator, split ring resonator (SRR), edge coupled SRR, double sided SRR, broadside coupled SRR, circular SRR, multiple SRR, and double sided multiple SRR. A preferred embodiment for the electromagnetic resonator is the split ring resonator (SRR).

Another embodiment of the invention is directed to the method of manufacturing a structural component with sensing capability, wherein the whole metastructure acts as an LC resonance circuit. For a double ring resonator, the resonance frequency of the structure f can be described by equations (1) and (2):

$$f = \frac{1}{2 π \sqrt{L C}} \qquad ( 1 )$$

where f is the resonance frequency and L is the inductance. The simplest expression for capacitance C can be given as:

$$C = {ε}_{0} {ε}_{r} \frac{A}{d} \qquad ( 2 )$$

where ε₀ is the relative permittivity of vacuum, εᵣ is the relative permittivity of the dielectric matrix, A is the area of the resonator and d is the distance between the two rings.

As shown in Eqs. (1-2), any change in the relative permittivity of the dielectric matrix Er (e.g., due to a temperature variation) or a change in geometry constants A and d.

Another embodiment of the invention is directed to a self-sensing metastructure comprising:
a) a structural component for metastructure; said material embedded with a sheet or plurality of electromagnetic resonator onto or beneath material surface to form embedded metastructure or metasurface arrays; said embedding process accomplished by 3-D printing;
b) said electromagnetic resonator selected from a group consisting of electrically conductive material or high dielectric material;
c) said metasurface selected from a group consisting of dielectric metasurface and plasmonic metasurface.

Another embodiment of the invention is directed to a self-sensing metastructure wherein the electromagnetic resonator is selected from a group consisting of closed ring resonator, split ring resonator (SRR), edge coupled SRR, double sided SRR, broadside coupled SRR, circular SRR, multiple SRR, and double sided multiple SRR.

Another embodiment of the invention is directed to a self-sensing metastructure, wherein the metasurface is dielectric metasurface; most preferably, with a high contrast (>5) in dielectric constant between the embedded metastructure and the surrounding structural material.

Another embodiment of the invention is directed to a self-sensing structural material, wherein the structural material is nonmetallic including ceramic and cement. The ceramic may either be sintered or unsintered. As used herein, sintering is the process of forming a dense solid mass of material by heating and compressing without melting it to the point of liquefaction. Examples of unsintered ceramics include compacted clay blocks that can be used as an engineered buffer material for nuclear waste disposal in geologic repositories. Examples of sintered ceramics include structural ceramics that can withstand high mechanical, thermal, and tribological stresses, corrosive environments, and high temperatures. Sintered ceramics can be used in applications such as gas turbines, welding nozzles, heat exchanges, heat pipes, and potentially container materials for nuclear waste management.

Another embodiment of the invention is directed to a self-sensing metastructure, wherein the metal is selected from a group consisting of copper, tungsten, high entropy (HE) alloys, and combinations thereof.

Another embodiment of the invention is directed to a self-sensing metastructure, wherein the plasmonic metasurface comprises multiple split ring resonator metal structure.

Another embodiment of the invention is directed to a self-sensing metastructure, wherein the plasmonic metasurface is in THz region.

Another embodiment of the invention is directed to a self-sensing metastructure, wherein the metal is copper; most preferably tungsten.

Another embodiment of the invention is directed to a self-sensing metastructure, wherein the sensor comprises a symmetric (polarization independent) copper resonator and four SRRs embedded in a dielectric material matrix; said dielectric matrix surrounding the resonator and protects the metal from harsh and corrosive environment.

Another embodiment of the invention is directed to a self-sensing metastructure, wherein the metastructure acts as an LC resonance circuit.

Another embodiment of the invention is directed to a self-sensing metastructure, wherein the sensor with a symmetric (polarization independent) copper resonator (comprised of four SRRs) embedded in a dielectric material matrix; said dielectric matrix surrounding the resonator protects the metal from harsh and corrosive environment.

Another embodiment of the invention is directed to the self-sensing metastructure wherein the whole metastructure acts as an LC resonance circuit. For a double ring resonator, the resonance frequency of the structure f can be described by equations:

$$f = \frac{1}{2 π \sqrt{L C}} \qquad ( 3 )$$

where f is the resonance frequency and L is the inductance. The simplest expression for capacitance (can be given as:

$$C = {ε}_{0} {ε}_{r} \frac{A}{d} \qquad ( 4 )$$

where ε₀ is the relative permittivity of vacuum, εᵣ, is the relative permittivity of the dielectric matrix, A is the area of the resonator and d is the distance between the two rings.

Another embodiment of the invention is directed to the self-sensing metastructure, wherein any change in the relative permittivity of the dielectric matrix, εᵣ (e.g., due to a temperature variation) or a change in geometry constants A and d due to structural strain or damage would change the capacitance and the resonance frequency of the structure.

Due to resonance frequency shift, the material structural changes can be detected. The structural health monitoring (SHM) of a material can be monitored passively and wirelessly using an external electromagnetic source and detector. SHM can possibly be extended to nested metastructures to detect material damage of a structural component and monitor the structural changes over an extended physical domain.

Another embodiment of the invention is directed to the self-sensing metastructure, wherein the dielectric resonators have same resonance as SRR resonators.

Another embodiment of the invention is directed to the self-sensing metastructure, wherein the size of resonator or mesh hole is about 100 μm to 1 centimeter (at least about one tenth of the wavelength of the sensing electromagnetic wave), preferably in millimeters. The frequency of the sensing electromagnetic wave ranges from 3 to 300 GHZ, preferably 30 GHZ.

As used herein, the term “about” as used herein can allow for a degree of variability in a value or range, for example, within 10%, within 5%, or within 1% of a stated value or of a stated limit of a range, and includes the exact stated value or range.

Another embodiment of the invention is directed to the self-sensing metastructure, wherein the resonance is about 3 to about 300 GHz; preferably about 10 GHz.

Another embodiment of the invention is directed to a method for SHM and to determine structural integrity of a structural component, passively, and wirelessly, comprising:
a) employing a self-sensing metastructure, electromagnetic source, and detector;
b) detecting the spectrum of a reflected or transmitted wave over a target physical domain of the structural component;
c) measuring resonance frequency shift of the wave to detect natural structural change;
d) evaluating structural health or environmental conditions by comparing the measured resonance frequency pattern and shift with the ones initially calibrated.

Another embodiment of the invention is directed to a method for SHM and determine structural integrity of a material wherein any change in structure of the material will affect the state of equilibrium of the embedded metastructures or metasurface array, altering the electromagnetic response of the material resulting in the frequency shift of reflection spectrum which can be detected passively and remotely.

Another embodiment of the invention is directed to a method for SHM and determine structural integrity of a material wherein structural health of a material can be monitored passively and wirelessly using an external electromagnetic source and detector.

Another embodiment of the invention is directed to a method for SHM and structural integrity of a material comprising application of self-sensing materials in structural integrity monitoring of wellbore plugging, in which borehole casing is used as a waveguide for focusing the electromagnetic wave to the wellbore plug.

Another embodiment of the invention is directed to a method of a random distribution of metastructures in a structural component. It is possible to 3-D print sensing unit cells and then mix them with other ingredients of a structural material in material preparation. This approach will be very useful to engineer self-sensing cements for wellbore plugging.

As used herein, “borehole” refers to a hole that is drilled to aid in the exploration and recovery of natural resources, including oil, gas, water, or heat from below the surface of the Earth. As used herein, a “wellbore” refers to a “borehole” either alone or in combination with one or more other components disposed within or in connection with the borehole in order to perform exploration and/or recovery processes.

Another embodiment of the invention is directed to a method for SHM and structural integrity of a material, wherein detection distance is about 1 meter to hundreds of meters.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The features, functions, and advantages discussed in the preceding section may be achieved independently in various embodiments or may be combined in other embodiments. Various embodiments will be hereinafter described with reference to drawings for purpose of illustrating the above-described invention and other aspects.

FIG. 1 is a diagram showing (A) Telemetrical sensing of structural integrity of a material with an embedded sheet of metastructures by detection of spectral shifts of a reflected or transmitted wave. Integrating a sheet of metastructures onto or directly beneath a material surface would also allow for the monitoring of environmental conditions. (B) Using casing as a waveguide to improve the sensing distance in a wellbore.

FIG. 2 is a diagram showing (A) Copper resonator with a dimension of 730 μm. (B) Simulated reflection resonance shift as a function of material strain.

FIG. 3 is a diagram showing a) Plasmonic metasurface unit cell, with the metasurface structure and array period. b) environment & measurement layout. c) illustration of the copper metasurface array.

FIG. 4 is a diagram showing Modelled reflectance data with the LC resonance under three conditions, the nominal design is shown in green, while red and blue show the effects of compression and tension. The insert shows the field profile and induced current density when the metasurface is illuminated with X polarized light.

FIG. 5 is a diagram showing Resonance frequency shift indicating whether the local metasurface is under compression or tension.

FIG. 6 is a diagram showing a) Dielectric metasurface unit cell, with structure dimensions shown, b) Materials, environment and measurement information, and c) illustration of the dielectric metasurface.

FIG. 7 is a diagram showing: a) Top—Modeled reflectance data with the high Q Fano resonance under the three compression conditions. The arrow points out the Fano resonance. The inset shows the field profile at the Fano resonance frequency and indicates the optimal incidence polarization. b) Bottom—A detailed view of the Fano resonance showing <1 GHz linewidth

FIG. 8 is a diagram showing Resonance frequency shift vs compression/tension of a dielectric metasurface shown in FIG. 6.

FIG. 9 is a diagram showing Image of RAISE3D E2 Multi-Material printer used for project

FIG. 10 is a diagram showing. (a, b) Image of multi-material print of zirconium silicate and copper mesh prepared with RAISE3D E2 Multi-Material Printer, (c) zirconium silicate side, and (d) mesh side.

### DETAILED DESCRIPTION

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art, such as, for example, the widely utilized.

### Metamaterial-Inspired Sensing

Metamaterial-based passive wireless sensing offers a promising alternative that can potentially transform the existing structural health monitoring practice.

Metamaterials are artificial materials engineered to provide properties that may not be available in nature. Metamaterials have been widely investigated and exploited for numerous functions, for example to obtain negative refractive index, reverse Doppler effect, etc. [5-8]. A metamaterial-based surface plasmon resonance sensor in the terahertz region was proposed by Arbabi et al. [9]. Melik et al. demonstrated a radiofrequency-microelectromechanical system and a nested split ring resonator (SRR)-based setup for strain measurements [10]. He et al. [10] developed a thin layer sensor with tip shaped SRR metamaterials for microwave region. Xia et al. [12] proposed a sensor based on a single SRR metamaterial structure for wireless sensing of gas density, temperature, gas pressure, etc. Ekmekci et al. [13] demonstrated the feasibility of double-sided split ring resonator structure for wireless sensors for applications in temperature, humidity, density, concentration, or pressure sensing. However, the metamaterial-based sensing concepts have not been explored for SHM, particularly in extreme environments commonly encountered in energy related applications. Also, the common methods of fabricating metastructures such as photolithographic or electron beam lithography make the fabrication complicated and costly [14].

### Additive Manufacturing

Metamaterials can be fabricated by introducing a metastructure into a material. The dimension of a unit cell metastructure is expected to be about a tenth of the wavelength of an external excitation used for sensing (on a scale of mm) [15,16]. As a result of the advance in additive manufacturing, a metastructure can now be readily engineered using 3-D printing. Sensors and structures are usually composed of physically and chemically distinct materials.

Traditionally, sensors are bonded with or embedded in a structural material, thus creating numerous inevitable issues such as stress concentration, debonding, and low reliability. In addition, sensors to be embedded are generally much larger in size than a typical metastructure referred in this invention, thus introducing significant discontinuities into a structural component and therefore directly impacting the mechanical properties of the component. In contrast, susing binder jetting or direct-write 3-D printing techniques, however, allows two materials, e.g., both metal and ceramic, to be printed in one machine, thus making it possible to seamlessly integrate a sensing capability into a structural component [17].

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

The methods and self-sensing metastructure of the present invention are illustrated further below by reference to examples which are intended to be illustrative and are not construed to limit the present invention in any way.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Principle of Self-Sensing Materials

The design of a single metastructure (or resonator) includes two aspects: the determination of an optimal geometry of the metastructure and the choice of sensing materials that make the structure. For example, for a typical ring resonator, a variety of structures have been proposed, including a) closed ring resonator, b) split ring resonator (SRR), c) edge coupled SRR, d) double sided SRR, e) broadside coupled SRR, f) broadside couple circular SRR, g) multiple SRR and h) double sided multiple SRR [14].

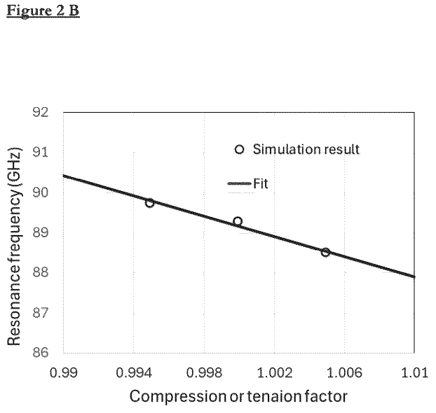

FIG. 2A shows a sensor with a symmetric (polarization independent) copper resonator (comprised of four SRRs) embedded in a dielectric material matrix. The dielectric matrix surrounding the resonator helps protect the metal from a harsh and corrosive environment.

The whole metastructure acts as an LC resonance circuit. For a double ring resonator, the resonance frequency of the structure f can be described by [14]:

$$f = \frac{1}{2 π \sqrt{L C}} \qquad ( 5 )$$

where f is the resonance frequency and L is the inductance. The simplest expression for capacitance C can be given as:

$$C = {ε}_{0} {ε}_{r} \frac{A}{d} \qquad ( 6 )$$

where ε₀ is the relative permittivity of vacuum, εᵣ, is the relative permittivity of the dielectric matrix, A is the area of the resonator and d is the distance between the two rings. As shown in Eqs. (1-2), any change in the relative permittivity of the dielectric matrix εᵣ (e.g., due to a temperature variation) or a change in geometry constants A and d (e.g., due to structural strain or damage) would change the capacitance and therefore the resonance frequency of the structure.

By measuring the resonance frequency shift, we can detect material structural changes [18], as shown in FIG. 2B. Unlike the existing active-circuit-based sensors, this new sensing approach eliminate all requirements for complicated environmental shielding, in-situ power supply and wire routing. The structural health of a material can then be monitored passively and wirelessly using an external electromagnetic source and detector.

The new concept can possibly be extended to nested metastructures to detect material damage of a structural component and monitor the structural change over an extended physical domain. It has been shown that a crack on a metal surface can be detected by scanning the surface with an open-ended waveguide probe enhanced with an array of SRR metastructures [19,20]. This is because, when the scanning probe approaches a crack, the near-field dielectric environment of the probe can be significantly altered by the presence of the crack. Based on the same principle, a metamaterial structure has been used for microfluidic sensors and chemical sensing [21-23].

Most metamaterials studied usually include a periodic distribution of metastructures with a uniform orientation. It is certainly interesting to examine the properties of a material with randomly embedded metastructures. One study on double split ring resonators has shown that the introduction of positional disorder in metamaterials has no effect on the quality factor of the inductive-capacitance resonance and dipole resonances undergo broadening and shift in their resonance frequencies [24].

This indicates that a random distribution of metastructures in a structural component may also be able to provide a self-sensing capability for a structural component, which may open a new possibility for engineering a self-sensing material. For example, we can first make sensing unit cells using 3-D printing and then mix them with other ingredients of a structural material in material preparation. This approach will be very useful to engineer self-sensing cements for wellbore plugging.

Numerical Simulation of Electromagnetic Wave Interaction with Metastructures

Metamaterials have become a powerful tool for engineering light matter interaction and have been applied to many domains [25]. Metasurfaces are a subset of metamaterials and are composed of an array of subwavelength structures that can be formed from metallic or dielectric constituent materials. The photonics principles that govern metasurface response are scalable and may be applied to many systems throughout the electromagnetic spectrum from visible to radio frequency (RF). Metasurfaces are a good fit for sensing because they are passive and strongly sensitive to the ambient environment and neighboring metastructures. Plasmonic metasurfaces (via metallic structures) are often used for RF or terahertz (THz) metasurfaces because in this frequency range metals have low loss [26-28]. Many plasmonic metasurface sensors have been investigated including a metamaterial-based surface plasmon resonance sensor in the THz region [29]. An RF micro-electro-mechanical system (MEMS) and a nested split ring resonator (SRR)-based setup for strain measurements [18]. A thin layer sensor with tip shaped SRR metamaterials for microwave region [11]. A sensor based on a single SRR metamaterial structure for wireless sensing of gas density, temperature, gas pressure, etc. [12]. A double-sided split ring resonator structure for temperature, humidity, density, concentration, or pressure sensing [11]. In addition, recently all-dielectric metasurfaces have been demonstrated as another approach for designing metasurface sensors. For example, to name just a few, a microfluidic refractive index sensor using silicon metasurfaces [30]. An ultrasensitive sensor in the THz range using high Q toroidal dipole resonances in dielectric metasurfaces [31] and a review of dielectric metasurface optical biosensors [32].

The described modeling was performed using COMSOL Multiphysics software which uses the finite element method to simulate the metasurface structures in an infinite array and calculate the reflection and transmission of the metasurface. COMSOL Multiphysics' Finite Element Method was used to model the optical properties (e.g. reflectance) of the unit cell of the described metasurfaces placed in a homogenous medium of refractive index 1.5 (cementitious material). The design parameters of the resonators and metasurface were selected such that the minimum feature size of the resonators was 50 μm, (the dielectric resonators were chosen such that their resonance was in the same range as the SRR based resonators). This places the resonances at ˜90 GHz, which can be adjusted by scaling the design or adjusting parameters. Ports were used at the top and bottom of the simulation region to apply the incident wave and analyze the reflected and transmitted fields. Floquet periodic boundaries were used on the boundaries of the simulation region. The mesh was chosen such that the maximum tetrahedron size was smaller than N/6. To measure compression and tension a scaling of the unit cell was performed along the X axis.

### Plasmonic Metasurface Design

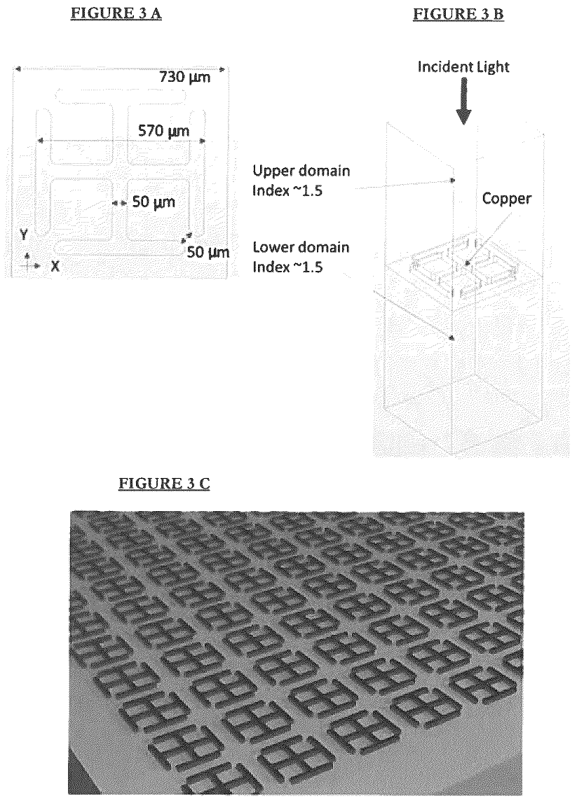

The plasmonic metasurface design (summarized in FIG. 3) comprises a multiple split-ring resonator copper structure [27,28] with a minimum feature size (gap) of 50 μm, and other dimensions as shown. The copper structure has a period of 730 μm in the metasurface array (FIG. 3a). The environmental configuration is shown in FIG. 3b, where the metasurface is surrounded by an environment with a refractive index of 1.5, with the incoming plane wave at normal incidence. The design is polarization-insensitive (due to symmetry) and thus there is no requirement on the polarization of the incident light.

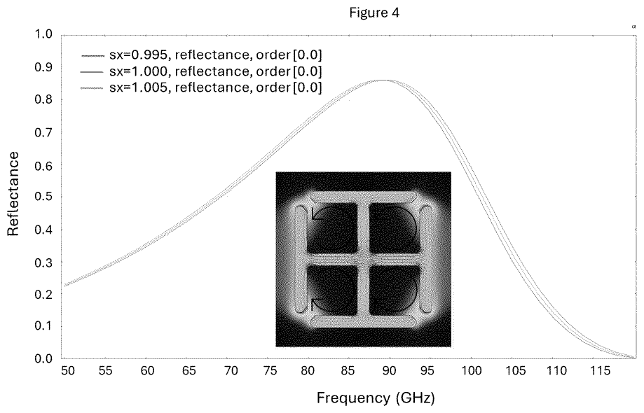

The design frequency of the metasurface is chosen to set the fundamental inductive-capacitive (LC) resonance at 89 GHz. The modeled reflection results are shown in FIG. 4, where the insert shows the field profile and the generated current density inside the structure when on-resonance.

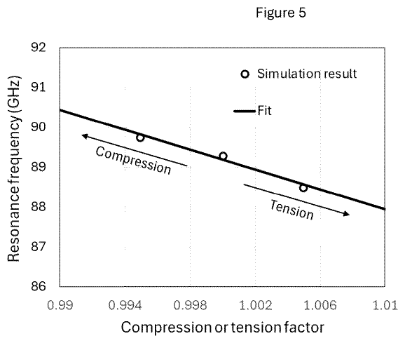

FIG. 4 also shows the effect of compressing or stretching the metasurface array. This is accomplished by scaling the entire geometry along the X coordinate. The nominal design is plotted in green (array period=730 μm), while the designs subject to 0.5% compression or tension are shown in red & blue respectively (corresponding to an array period of 726.5 μm & 733.5 μm). The center resonance frequency for each case is plotted in FIG. 5.

### Dielectric Metasurface Design

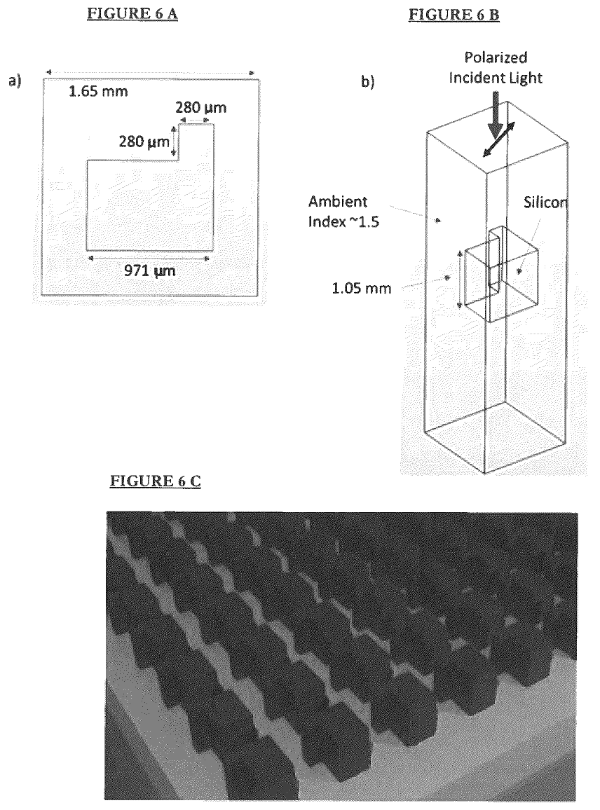

In this design, we break the in-plane inversion symmetry of the resonator structure [33,34] which allows coupling into an otherwise protected bound state in the continuum (BIC). This quasi-BIC resonance has a Fano shape with ˜1 GHz resonance linewidth. These metasurfaces are sensitive to intra-array characteristics. When the array is deformed the resonance shifts can be detected. In this case, the metasurface unit cell is not symmetric, and as a result, the resonance is strongest when light is polarized as shown (˜36 degrees from x axis) (FIG. 6).

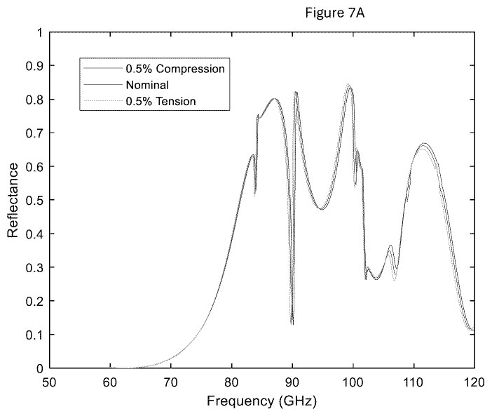

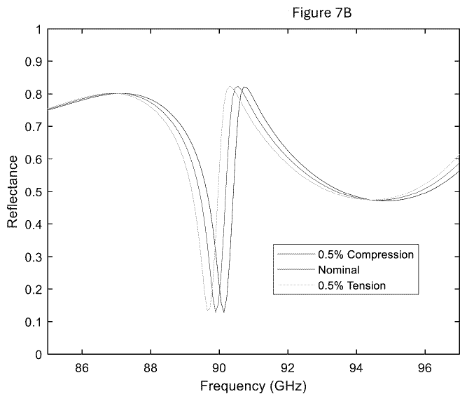

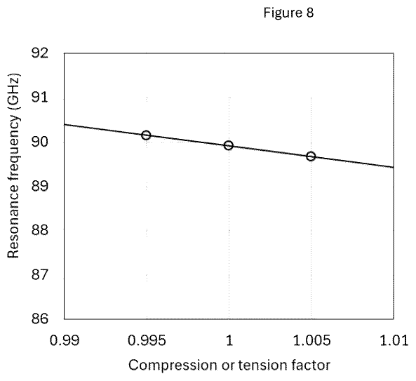

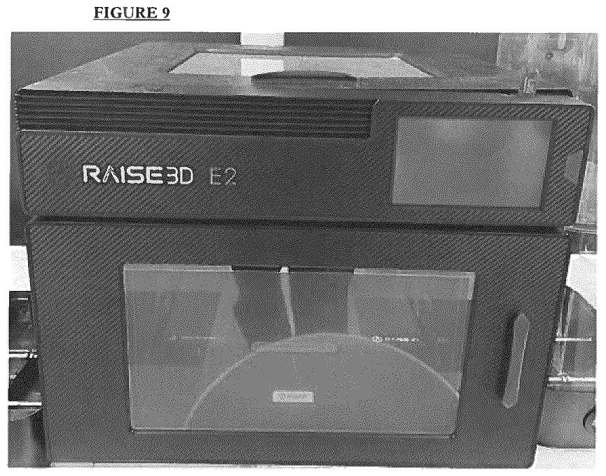

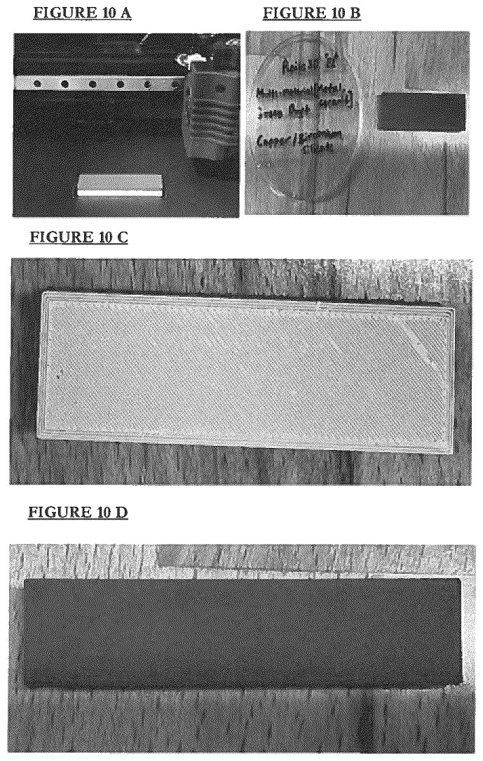

The design frequency of the metasurface is chosen to set the quasi-BIC resonance at 90 GHz. The broadband reflection results are shown in FIG. 7 along with a detailed zoom of the high Q resonance. The insert shows the field profile at the resonance frequency. Compressed and stretched simulations are also plotted. This is accomplished by scaling the entire geometry in plane isometrically (X & Y). The nominal design is plotted in red (array period=1647 μm), while the designs subject to 0.5% compression or tension are shown in blue & yellow respectively (corresponding to an array period of 1639 μm & 1655 μm). The center resonance frequency for each case is plotted versus the compression ratio in FIG. 8.

A comparison of the performance of dielectric metasurface (FIG. 8) with the plasmonic metasurface was performed (FIG. 5). The dielectric has a high Q resonance which may be easier to experimentally measure. The resonance frequency shifts less for a given percent change in geometry scaling. FIG. 8 provides the resonance frequency shift vs. compression/tension of dielectric constant as shown in FIG. 6.

### 3-D Printing of Ceramic-Metal Materials

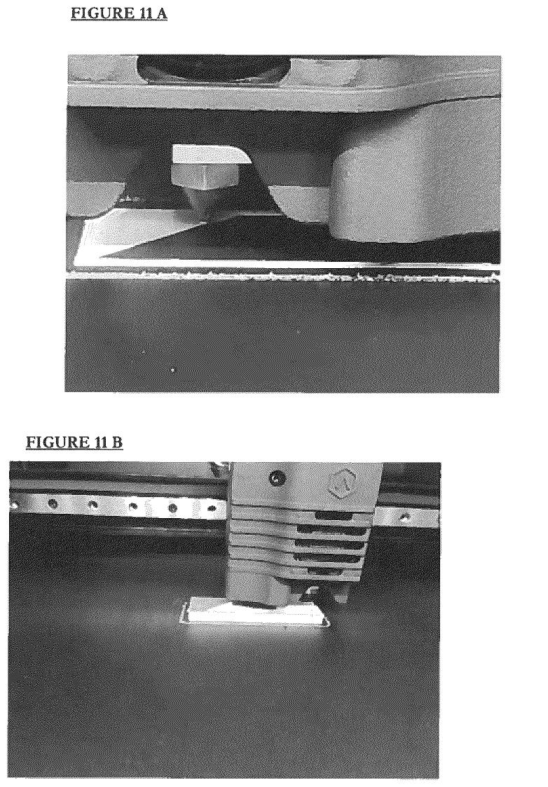

In exploring the feasibility of using additive manufacturing to engineer metastructured self-sensing materials, we tested multi-material printing of ceramic and metal using 3-D printing capabilities at V. M. Keck Center for 3D Innovation at University of Texas at El Paso. The ceramic of selection was zirconium silicate and the metal was copper as they have near melting temperatures which would allow us to achieve printability. The printer that was selected for this project was a RAISE3D E2 (3D Printers Depot) Multi-Material printer has the capabilities to reach a nozzle temperature of 300° C. with a max build plate temperature of 110° C., a fully enclosed chamber, and a flexible build plate for easy removal of 3D printed models as seen in FIG. 9.

The printer also has the capabilities of mirror mode printing of 3D models and its mirror simultaneously as well as a duplicate mode which allows synchronized printing with both extruders for double the production capacity.

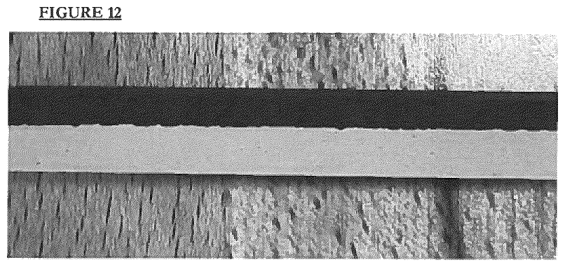

FIG. 9 provides the image of RAISE3D E2 Multi-Material printer used for the project. The printing parameters were set using Ultimaker Cura 4.11.0 slicing software to generate the G-code in order to print out the sample with the nozzles. As shown in FIG. 10, a basic sample with ceramic base with copper mesh printed on top was achieved. The dimensions of the part where a length of 19.28 mm, a width of 66 mm, and a height of ceramic of 5 mmm with a 3 mm height of copper. The printing parameters required to print the sample were a printing speed of 20 m/s, nozzle temperature of 235° C. and a bed temperature of 60° C.

### Material Selection for Metastructure

The present invention is directed to print out two materials layer by layer ceramic and copper. The zirconium silicate has a higher sintering temperature than copper (1500° C. and 1052° C., respectively). It is not clear that the copper infrastructure embedded would remain stable during sintering. Other materials of interest include tungsten, Inconel, and silicon carbide, which have higher sintering temperatures. For example, tungsten has sintering temperature of 2200° C., which could make tungsten as an ideal material for metastructure embedded in ceramics.

In energy related applications, high temperature and corrosive environments can be encountered. Corrosive resistance and thermal stability of a material are two important parameters that need to be considered in material selection. Recently emerging high entropy alloys (HEAs) could be good candidates for applications in extreme environments. HEAs are a novel set of alloys formed by mixing equal or relatively large proportions of multiple elements, resulting in a large entropic contribution to material stability, especially at elevated temperatures (35).

### Using Casing as a Waveguide for Downhole Monitoring

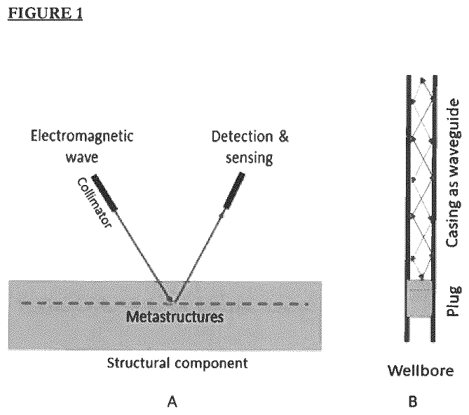

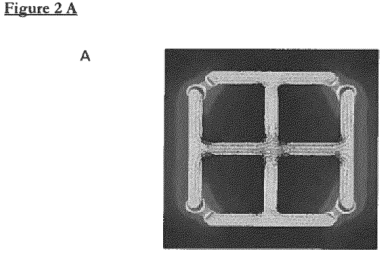

One potential application of the self-sensing materials is the structural integrity monitoring of wellbore plugging. A preliminary evaluation was performed using borehole casing as a waveguide to improve the detection distance for monitoring the structural integrity of a cement plug in a wellbore (FIG. 1B). Assuming the empty space above a cement plug in a wellbore is filled with air, given a near-zero loss of an electromagnetic wave in air, the detection distance could potentially be extended to hundreds of meters. The propagation of an electromagnetic wave in a wellbore using casing as a wave guide can be simulated to provide a more accurate estimation of the detection range [36].

TABLE I
Acronym/Terms

| Acronym/Terms | Definition |
|---|---|
| BIC | Bound state in the continuum |
| HEA | High entropy alloy |
| LDRD | Laboratory Directed Research |
| | & Development |
| RF | Radio frequency |
| SAW | Surface acoustic wave |
| SHM | Structural health monitoring |
| SRR | Split ring resonator |

### CONCLUSION

The present invention explored a new concept for structural health monitoring (SHM) by introducing a self-sensing capability into a structural component. The concept is based on two recent technological advances: metamaterials and additive manufacturing. A self-sensing capability can be engineered by embedding a metastructure, for example, a sheet of electromagnetic resonators or mesh, either metallic or dielectric, into a material component. This embedment can now be possibly realized using 3-D printing. The precise geometry of the embedded metastructure determines how the material interacts with an incident electromagnetic wave. Any change in the structure of the material (e.g., straining, degradation, etc.) would inevitably perturbate the embedded metastructures or metasurface array and therefore alter the electromagnetic response of the material, thus resulting in a frequency shift of a reflection spectrum that can be detected passively and remotely.

The new sensing approach eliminates complicated environmental shielding, in-situ power supply, and wire routing that are generally required by the existing active-circuit-based sensors.

### REFERENCES

The following references, as well as other references cited in the present application, to the extent that they provide exemplary procedural or other details supplementary to those set forth herein, are specifically incorporated herein by reference.
[1] Deivasigamani, A., Daliri, A., Wang, C. H., and John, S. (2013) A review of passive wireless sensors for structural health monitoring, Modern Applied Sci., 7 (2), 57-76.
[2] Karim, H., Delfin, D., Chavez, L. A., Delfin, L., Martinez, R., Avila, J., Rodriguez, C., Rumpf, R. C., Love, N., and Lin, Y. (2017) Metamaterial based passive wireless temperature sensor, Adv. Eng. Materi., 19 (5), 1600741.
[3] Yang, J. (2013) A silicon carbide wireless temperature sensing system for high temperature applications, Sensors, 13 (2), 1884-1901.
[4] Tan, Q., Kang, H., Xiong, J., Qin, L., Zhang, W., Li, C., Ding, L., Zhang, X., and Yang, M. (2013) A wireless passive pressure microsensor fabricated in HTCC MEMS technology for harsh environments, Sensor, 13 (8), 9896-9908.
[5] Cai, W., Chettiar, U. K., Kildishev, A. V., and Vladimir, M. S. (2007) Optical cloaking with metamaterials, Nature Photon., 1 (4), 224-227.
[6] Schurig, D., Mock, J. J., Justice, B. j., Cummer, S. A., Pendry, J. B., Starr, A. F., and Smith, D. R. (2006) Metamaterial electromagnetic cloak at microwave frequencies, Science, 314 (5801), 977-980.
[7] Smith, D. R., Pendry, J. B. and Wiltshire, M. C. K. (2004) Metamaterials and negative refractive index, Science, 305 (5685), 788-792.
[8] Lee, S. H., Park, C. M., Seo, Y. M., and Kim, C. K. (2010) Reversed Doppler effect in double negative metamaterials, Phys. Rev. B, 81 (24), 241102.
[9] Arbabi, A., Rohani, A., Saeedkia, D., and Safavi-Naeini, S. (2008) A terahertz plasmonic metamaterial structure for near-field sensing applications, in Proc. 33rd Int. Conf. Infr., Millimeter Terahertz Waves, 2008, pp. 1-2.
[10] Melik R. Unal, E., Perkgoz, N. K., Santoni, B., Kamstock, D., Puttlitz, C., and Demir, H. V. (2010) Nested metamaterials for wireless strain sensing, IEEE J. Sel. Topics Quantum Electron., 16 (2), 450-458.
[11] He, X.-J., Wang, Y., Wang, J.-M. and Gui, T.-L. (2010) Thin-film sensor based tip-shaped split ring resonator metamaterial for microwave application, Microsyst. Technol., 16 (10), 1735-1739.
[12] Xia, Y. and Wang, L. (2008) A wireless sensor using left-handed metamaterials, in Proc. 4th Int. Conf. Wireless Commun., Netw. Mobile Comput., October 2008, pp. 1-3.
[13] Ekmekci E. and Turhan-Sayan, G. (2013) Multi-functional metamaterial sensor based on a broad-side coupled SRR topology with a multi-layer substrate, Appl. Phys. A, 110 (1), pp. 189-197.
[14] Karim, H., Delfin, D., Ishtiaque, M. A., Chavez, L. A., Garcia, C. R., Barton, J. H., Gatan, S. M., Cadenna, M. A., Rumpf, R. C., Wicker, R. B., Lin, Y. and Choudhuri, A. (2015) Concept and model of a metamaterials-based passive wireless temperature sensor for harsh environment applications, IEEE Sensors J., 5 (3), 1445-1452.
[15] Lee, Y., Kim, S.-J., Park, H. and Lee, B. (2017) Metamaterials and metasurfaces for sensor applications, Sensors, 17, 1726.
[16] Chen, T., Li, S. and Sun, H. (2012) Metamaterials application in sensing, Sensors, 12, 2742-2765
[17] Kim, H., Torres, F., Wu, Y., Villagran, D., Lin, Y. and Tseng, T.-L. (2017) Integrated 3D printing and corona poling process of PVDF piezoelectric films for pressure sensor application, Smart Mater. Struct. 26, 085027.
[18] Melik, R, Unal, E., Perkgoz, N. K., Santoni, B., Kamstock, D., Puttltz, C. and Demir, H. V. (2010) Nested metamaterials for wireless strain sensing, IEEE J. Selected Topics in Quantum Electronics, 16 (2), 450-458.
[19] Ali, A., Hu, B. and Ramahi, O. M. (2015) Intelligent detection of cracks in metallic surfaces using a waveguide sensor loaded with metamaterial elements, Sensors, 15, 11402-11416.
[20] Albishi, A. and Ramahi, O. M. (2014) Detection of surface and subsurface cracks in metallic and nonmetallic materials using a complementary split-ring resonator, Sensors, 14, 19354-19370.
[21] Sliam, A. and Lim, S. (2018) Review of recent metamaterial microfluidic sensors, Sensors, 18, 232.
[22] Saghati, A. P., Batra, J. S., Kameoka, J., and Entesari, K. (2017) A metamaterial-inspired wideband microwave interferometry sensor for dielectric spectroscopy of liquid chemicals, IEEE Trans. Microwave Theory Tech., 65 (7), 2558-2571.
[23] Jeong, J., Goldflam, M. D., Campione, S., Briscoe, J. L., Vabishchevich, P. P., Nogan, J., Sinclair, M. B., Luk, T. S. and Brener, I. (2020) High quality factor toroidal resonances in dielectric metasurfaces, ACS Photonics 2020, 7, 7, 1699-1707.
[24] Singh, R., Lu, X., Gu, J., Tian, Z. and Zhang, W. (2010) Random terahertz metamaterials, J. Opt., 12, 015101.
[25] Chen, H. T., Yaylor, A. J. and Yu, N. (2016) A review of metasurfaces: physics and applications, Rep. Prog. Phys. 79, 076401.
[26] Gay-Balmaz, P. and Martin, O. J. F. (2002) Electromagnetic resonances in individual and coupled split-ring resonators, J. Applied Physics. 92 (5): 2929.
[27] Chen, H. T., Padilla, W. J., Cich, M. J., Azad1, A. K., Averitt, R. D. and Taylor1, A. J. (2009) A metamaterial solid-state terahertz phase modulator, Nature Photonics, 3, 148-151 (2009)
[28] Karl, N., Reichel, K, Chen, H.-T., Taylor, A. J., Brener, I., Benz, A., Reno, J. L., Mendis, R. and Mittleman, D. M. (2014) An electrically driven terahertz metamaterial diffractive modulator with more than 20 dB of dynamic range, Applied Physics Letters, 104, 091115.
[29] Arbabi, A., Rohani, A., Saeedkia, D. and Safavi-Naeini, S. (2008) A terahertz plasmonic metamaterial structure for near-field sensing applications, Proc. 33rd Int. Conf. Infr., Millimeter Terahertz Waves, 2008, pp. 1-2.
[30] Ollanik, A. and Escarra, M. D. (2018) Highly Sensitive Refractive Index Sensing with Silicon-Based Dielectric Metasurfaces, 2018 Conference on Lasers and Electro-Optics (CLEO).
[31] Wang, Y., Han, Z. and Du, Y. and Qin, J. (2021) Ultrasensitive terahertz sensing with high-Q toroidal dipole resonance governed by bound states in the continuum in all-dielectric metasurface, Nanophotonics, 10 (4), 1295-1307.
[32] Tseng, M. L., Jahani, Y., Leitis, A., and Altug, H. (2021) Dielectric Metasurfaces Enabling Advanced Optical Biosensors, ACS Photonics 2021, 8, 1, 47-60.
[33] Campione, S., Liu, S., Basilio, L. I., Warne, L. K., Langston, W. L., Luk, T. S., Wendt, J. R., Reno, J. L., Keeler, G. A., Brener, I. and Sinclair, M. B. (2016) Broken Symmetry Dielectric Resonators for High Quality Factor Fano Metasurfaces; ACS Photonics, 3, 2362-2367
[34] Karl, N., Vabishchevich, P. P., Liu, S., Sinclair, M. B., Keeler, G. A., Peake, G. M. and Brener, I. (2019) All-optical tuning of symmetry protected quasi bound states in the continuum, Appl. Phys. Lett. 115, 141103.
[35] Tsai, M.-H. and Yeh, J.-W. (2014) High-entropy alloys: A critical review, Materials Research Letters, 2, 107-123.
[36] Cunha, A. A. L., and Pacheco, M. A. (2015) A Simulation model for electromagnetic wave propagation within production pipes of oil wells, OTC Brasil, Rio de Janeiro, Brazil, October 2015, OTC-26218-MS.

Without further description, it is believed that one of ordinary skill in the art can, using the preceding description and illustrative examples, make, utilize and practice the claimed methods. It should be understood that the foregoing discussion and examples merely present a detailed description of certain preferred embodiments. It will be apparent to those of ordinary skill in the art that various modifications and equivalents can be made without departing from the spirit and scope of the invention. All the patents, journal articles and other documents discussed or cited above are herein incorporated by reference.

1. A self-sensing metastructure comprising:
a) a structural component for metastructure; said material embedded with a sheet or multiple sheets of electromagnetic resonator or a layer or multiple layers of meshes of an electrically conductive material onto or beneath surface of a structural component to form embedded metastructure or metasurface arrays; said embedding process accomplished by 3-D printing;
b) said electromagnetic resonator selected from a group consisting of electrically conductive material and high dielectric material; and
c) a metasurface surrounding the resonator; said metasurface selected from a group consisting of dielectric metasurface or plasmonic metasurface.

2. The self-sensing metastructure according to claim 1, wherein the electromagnetic resonator is selected from a group consisting of closed ring resonator, split ring resonator (SRR), edge coupled SRR, double sided SRR, broadside coupled SRR, circular SRR, multiple SRR, and double sided multiple SRR.

3. The self-sensing metastructure according to claim 1, wherein the metasurface is a dielectric metasurface.

4. The self-sensing metastructure according to claim 1, wherein the dielectric material is SrTiO₃, BaTiO₃, LaAlO₃, TiO₂, Nb₂O₅, Ta₂O₅, HfSiO₄, ZrO₂, Al₂O₃, silicon carbide, and materials having dielectric constants greater than 5 to achieve significant contrast in dielectric constant of at least greater than 5 between the metastructure and surrounding structural component.

5. The self-sensing metastructure according to claim 1, wherein the electrically conductive material is selected from a group consisting of copper, nickel, tungsten, aluminum, carbon steel, stainless steel, high entropy (HE) alloys, graphite, conductive polymer, and other materials having high melting temperatures greater than 300° C.; wherein said graphite is selected from graphene and carbon fiber.

6. The self-sensing metastructure according to claim 1, wherein the electrically conductive material for mesh metastructure is selected from carbon steel, stainless steel, and copper.

7. The self-sensing metastructure according to claim 1, wherein the plasmonic metasurface comprises multiple split ring resonator metal structure.

8. The self-sensing metastructure according to claim 1, wherein the plasmonic metasurface is about 3 to 300 GHz.

9. The self-sensing metastructure according to claim 1, wherein the electrically conductive material is copper or FeCoNiCrCu high entropy alloy.

10. The self-sensing metastructure according to claim 1, comprising a symmetric copper resonator and four SRRs embedded in a dielectric material matrix; said dielectric matrix surrounding the resonator and protecting the copper metal from harsh and corrosive environment; wherein said symmetric copper resonator is polarization independent.

11. The self-sensing metastructure according to claim 1, wherein the metastructure acts as an LC resonance circuit.

12. The self-sensing metastructure according to claim 1, wherein for a double ring resonator, the resonance frequency of the structure f can be described by formula:
$$f = \frac{1}{2 π \sqrt{L C}}$$
where f is the resonance frequency and L is the inductance. The simplest expression for capacitance C can be given as:
$$C = {ε}_{0} {ε}_{r} \frac{A}{d}$$
where ε₀ is the relative permittivity of vacuum, εᵣ, is the relative permittivity of the dielectric matrix, A is the area of the resonator and d is the distance between the two rings.

13. The self-sensing metastructure according to claim 12, wherein any change in the relative permittivity of the dielectric matrix εᵣ is due to a temperature variation or a change in geometry constants A and d.

14. The self-sensing metastructure according to claim 1, wherein the dielectric resonators have the same resonance as SRR resonators.

15. The self-sensing metastructure according to claim 12, wherein the size of resonator is about 100 μm to 1 centimeter.

16. The self-sensing metastructure according to claim 12, wherein the resonance is about 3 to 300 GHz.

17. The self-sensing metastructure according to claim 1, wherein the structural component material is a nonmetallic material selected from a group consisting of ceramic or cement; wherein said ceramic is either sintered or unsintered.

18. The self-sensing metastructure according to claim 1, prepared by a process comprising the steps of:
a) embedding a metastructure with a sheet or multiple sheets of electromagnetic resonators or a layer or multiple layers of meshes of an electrically conductive material on or beneath surface of a structural component material forming embedded metastructures or metasurface arrays; and
b) conducting the embedding process by 3-D printing.

19. The self-sensing metastructure according to claim 1, for monitoring SHM and determining structural integrity of a material passively, remotely, and wirelessly, comprising:
a) employing the self-sensing metastructure, electromagnetic source, and detector;
b) detecting spectral shifts of a reflected or transmitted wave;
c) measuring resonance frequency shift to detect natural structural change;
d) evaluating structural health or environmental conditions by comparing the measured resonance frequency pattern and shift with the ones initially calibrated.

20. The self-sensing metastructure according to claim 19, for application in structural integrity monitoring of well bore plugging using well casing as a wave guide.
